(19) United States
(12) Patent Application Publication
(10) Pub. No.: US 2025/0285469 A1
(43) Pub. Date: Sep. 11, 2025

(54) METHODS FOR DETERMINING EYE GAZE DIRECTION IN DIGITAL IMAGES USING APPLIED ARTIFICIAL NEURAL NETWORKS

(71) Applicant: Kodak Alaris LLC, Rochester, NY (US)

(72) Inventors: Karan Manghi, Rochester, NY (US); Alexander Loui, Rochester, NY (US)

(73) Assignee: Kodak Alaris LLC, Rochester, NY (US)

(21) Appl. No.: 19/075,027

(22) Filed: Mar. 10, 2025

Related U.S. Application Data
(60) Provisional application No. 63/562,828, filed on Mar. 8, 2024.

(51) Int. Cl. G06V 40/18; G06V 10/82

(52) U.S. Cl. CPC G06V 40/18; G06V 10/82

(57) ABSTRACT

Methods and systems for detecting eye gaze direction in digital images. Digital images can be brightness corrected prior to being processed by a convoluted neural network trained for eye gaze detection. Brightness correction can result in greater accuracy by providing images of similar brightness to the images the convoluted neural network was trained on. The convolutional neural network can use multiple convolution layers, fully connected layers, batch normalization, rectified linear activation functions, and dropout to process an image for gaze determination.

### CROSS-REFERENCE TO RELATED APPLICATIONS

This application is a non-provisional of and claims the benefit of priority to U.S. Provisional Application Ser. No. 63/562,828, filed Mar. 8, 2024, which is incorporated in its entirety herein for all purposes.

### BACKGROUND

### Field of Disclosure

This disclosure relates, in general, to image processing techniques, and in particular, to systems and methods for determining eye gaze detection in digital images.

### Description of the Prior Art

Various information can be determined through the analysis of the human vision system. By observing the eyes of an individual, determinations can be made as to pupil size, eye direction, and changes in eye state, for example: opening, closing, blinking, and crying. This information can be used to estimate emotions, traits, or interests. To analyze the eye, image processing is an important task, and the development and availability of wearable cameras and recording devices have made image processing, including gaze estimation, increasingly easier.

One wearable way to estimate eye gaze is through a gaze estimation system (“GES”). A GES involves multiple cameras, and such systems can estimate gaze direction and what a user is looking at. One type of GES uses an inside-out camera, which is comprised of an eye camera and a scene camera. The eye camera captures images of the user's eyes while the scene camera captures images of the scene that the user is viewing. Such a GES detects the pupil center and maps it to a point in the scene image. Recently, GESs have been used in various applications, such as video summarization, daily activity recognition, reading, human-machine interfaces, and communication support.

With these systems, it can be difficult to detect the pupil center because the eye is a nonrigid object, users blink frequently, and eyelid or eyelashes can occlude the pupil. Furthermore, the iris has various colors, such as blue, brown, and black. However, when an infrared camera is used to capture eye images, the iris fades out, which makes the pupil clearer. The use of infrared cameras can make the eye image easy to work with. However, blinking remains problematic because it is difficult to detect the pupil center point when a user blinks. Consequently, gaze direction errors can occur.

Additionally, without the presence of a GES or infrared camera it can be even more difficult to detect eye gaze. In digital images that have been pre-recorded without the use of a GES or infrared camera, it can be difficult to determine gaze.

### SUMMARY

Applicant recognized the problems noted above herein and conceived and developed embodiments of systems and methods, according to the present disclosure, for gaze detection.

In various embodiments of the present disclosure, a computer-implemented method for eye gaze determination in images includes using a reference image luminous value to adjust a brightness of an image for input to a Convolutional Neural Network (CNN) deep learning model, reducing one or more dimensions of the image, inputting the image to the CNN model, determining a location of an eye pupil within the image, and providing an indication of eye gaze direction for the image.

In one or more embodiments of the present disclosure, a method for training a CNN model to detect eye gaze direction includes pre-processing a training image, inputting the training image to the CNN model, processing the training image through one or more layers, indicating an eye gaze determination of the output from the CNN model, and adjusting internal parameters of the CNN model.

This disclosure presents a CNN model to learn and detect eye gaze direction and a brightness correction system and method to normalize the input digital images so that their brightness appears similar to selected training images. A CNN can be trained using various internal parameters. The CNN processes training images through multiple layers, adjusting its internal parameters to minimize errors in gaze detection. A separate set of test images can be passed into the CNN to validate the eye gaze direction detection. The test images can be brightness corrected using the provided method before passing into the trained network.

Unlike systems developed for computers with monitored mounted cameras, embodiments of the present disclosure can detect eye gaze position without a known position for a viewable target. Various embodiments of the present disclosure can include but are not limited to biometric photo identification systems and automatic photo collage arrangements and compositions. For photo identification systems, detection of a forward-facing gaze may be used for photo identification documents. In regard to photo collage arrangements, gaze identification can be used as a qualification for image selection and placement. The present disclosure may also be used to trigger image capture when a subject's eye gaze is in the desired orientation or to select digital images with a desired eye gaze orientation from a group of images.

One embodiment of the present disclosure relates to a computer implemented method for determining eye gaze in digital images. The method includes training a CNN with training images to generate a trained CNN. Before images are provided to the CNN, the images can be brightness adjusted. Adjusting the brightness of the images can result in more accurate gaze detection by the CNN.

The brightness adjusted images can be input into the CNN. The CNN can use a rectified linear activation function (“ReLU”) after dense and convolution layers and dropout after one or more dense layers. The CNN can further use batch normalization after a first convolution layer and after one or more dense layers. The output from the CNN can indicate both a location of the eye pupils in the image and an eye gaze direction for the image.

The method can further include using a digital library (“DLIB”) of test images. The method can extract facial feature points including eye features from the test images. The facial feature extraction step can further include cropping the test image and annotating eye regions for input into the CNN. The cropped and annotated DLIB images can be used for the training of the CNN.

The CNN can further include five convolution layers and three fully connected layers. The ReLU can be used for all convolution layers and the ReLU and dropout can be used after the first and second dense layers.

For the brightness adjusting element, the brightness can be adjusted by modifying a luminance part of a Hue Saturation Luminance (“HSV”) representation of the image. A reference image luminance value can be identified from the training images. The luminance value can be the sum of all luminance vector elements of the reference image. Dividing the reference image luminance value by the luminance value of the new image can result in a reference ratio. The reference ratio can be used to determine the luminance adjustment. The reference luminous value can be between 322500 and 327000.

The CNN can further be trained with an Adaptive Moment Estimation (“Adam”) as an optimizer. The Adam algorithm can have a learning rate of 0.0001, can be trained for 40 epochs, and can use a ground truth dataset of images with a resolution of 120×80×3 pixels per image.

The eye gaze direction indication can further be provided as an “x”, “y” location of an eye center, pass/fail indication, visual cue, or audio cue. The indication can result in the selection of the image from a group of images or triggering the recording of the image when compliant with a selected eye gaze direction. The method can provide audio or visual instructions for a live (real time) recording to bring the subject's eye gaze into compliance with the selected eye gaze direction. The method can further include a user interface for facilitation of certain desired eye gaze directions.

### BRIEF DESCRIPTION OF THE DRAWINGS

The present disclosure will be better understood on reading the following detailed description of non-limiting embodiments thereof, and on examining the accompanying drawings, in which:

FIG. 1 is a schematic diagram of an environment for eye gaze direction using a CNN model, according to various embodiments of the present disclosure.

FIG. 2 is a flowchart for a method of training a neural network, according to an embodiment of the present disclosure.

FIG. 3 is a flowchart illustrating an CNN architecture, according to an embodiment of the present disclosure.

FIG. 4 is a flowchart for a method of adjusting the brightness of a digital image, according to an embodiment of the present disclosure.

FIGS. 5A-5F are eye gaze detection scenarios.

FIGS. 6A-6F are eye gaze detection feedback scenarios.

FIGS. 7A-7C are embodiments of systems for performing gaze detection feedback.

### DETAILED DESCRIPTION

The foregoing aspects, features and advantages of the present disclosure will be further appreciated when considered with reference to the following description of preferred embodiments and accompanying drawings, wherein like reference numerals represent like elements. In describing the preferred embodiments of the disclosure illustrated in the appended drawings, specific terminology will be used for the sake of clarity. The present disclosure, however, is not intended to be limited to the specific terms used, and it is to be understood that each specific term includes equivalents that operate in a similar manner to accomplish a similar purpose. Furthermore, it should be appreciated that steps for methods discussed in the present disclosure and illustrated in the figures may be performed in any order, or in parallel, unless otherwise specifically stated. Moreover, methods may include more or fewer steps.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments,” or “other embodiments” of the present disclosure are not intended to be interpreted as excluding the existence of additional embodiments that also incorporate the recited features. Furthermore, reference to terms such as “above,” “below,” “upper”, “lower”, “side”, “front,” “back,” or other terms regarding orientation are made with reference to the illustrated embodiments and are not intended to be limiting or exclude other orientations or directions. Moreover, references to “substantially” or “approximately” or “about” may refer to differences within ranges of +/−10 percent.

Embodiments of the present disclosure are directed towards systems and methods for detecting eye gaze direction in a digital image. In various embodiments, a CNN can be trained with training images for use in detecting eye gaze direction. Digital images that are analyzed by the CNN can be adjusted to a specified brightness to assist with the gaze detection CNN. The resulting gaze direction can then be used in various embodiments for the production of identification documents or other photo media.

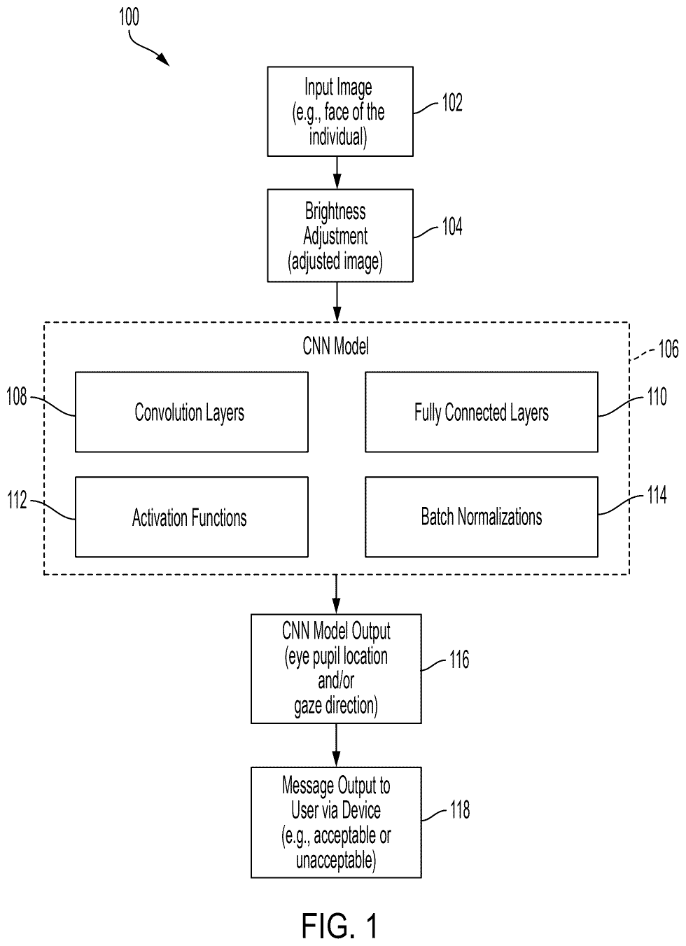

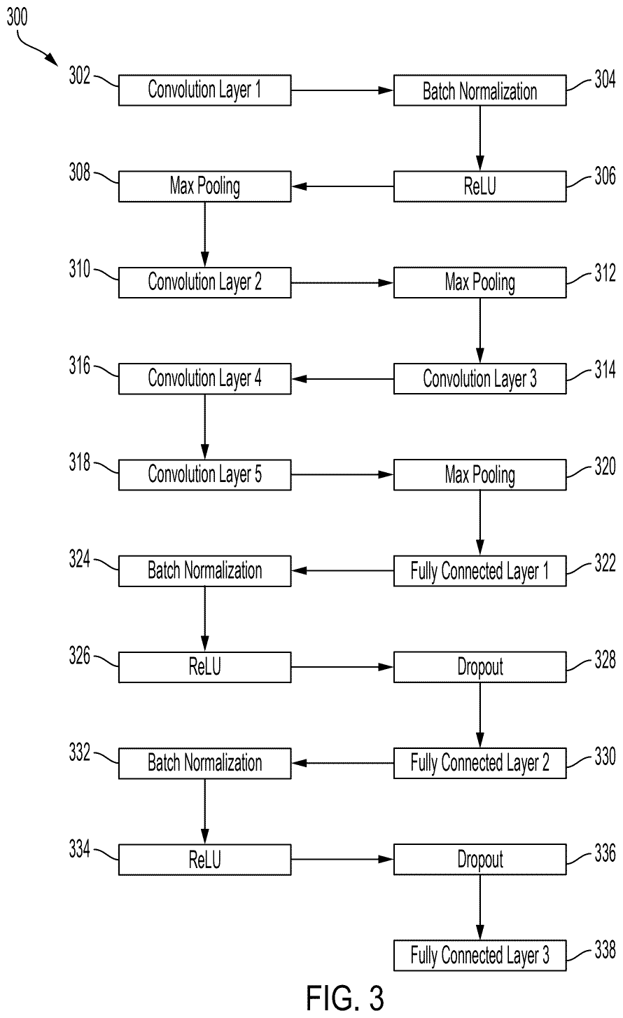

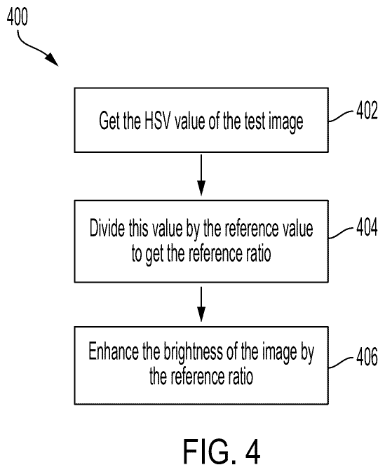

FIG. 1 is an environment 100 for detecting eye gaze using a CNN, according to various embodiments of the present disclosure. At the outset, an input image 102 can be received. The input image 102 may be a picture of a person's face. In various embodiments, the input image 102 is the image of the face of the user of a device, such as a smartphone, tablet, or computer, as described more in detail below. After receiving the input image 102, the image may be brightness adjusted 104. The brightness adjustment step is provided in greater detail in FIG. 4 and below. The brightness adjusted image may be input to the CNN model 106. The CNN model 106 may include one or more convolution layer 108, one or more fully connected layers 110, one or more activation functions 112, and one or more batch normalization steps 114. The CNN model 106 used is described in additional detail in FIG. 3 and below.

In some embodiments, the CNN model 106 may provide a CNN model output 116. The CNN model output 116 can include an eye image classification which can be open, medium, or closed. Images classified as open or medium by the CNN model can be further analyzed for detecting eye gaze direction which may also be included in the CNN model output 116. Images with eyes classified as closed may not be further analyzed by the CNN model. The CNN model output 116 may also be an indication of eye pupil location and/or gaze direction. This indication may or may not be presented to the user of the CNN model environment 100. Based on the CNN model output 116, a message output 118 may be presented to the user. In some embodiments, the message output 118 includes an indication that the eye gaze direction is unacceptable or acceptable, based on a desired eye gaze direction.

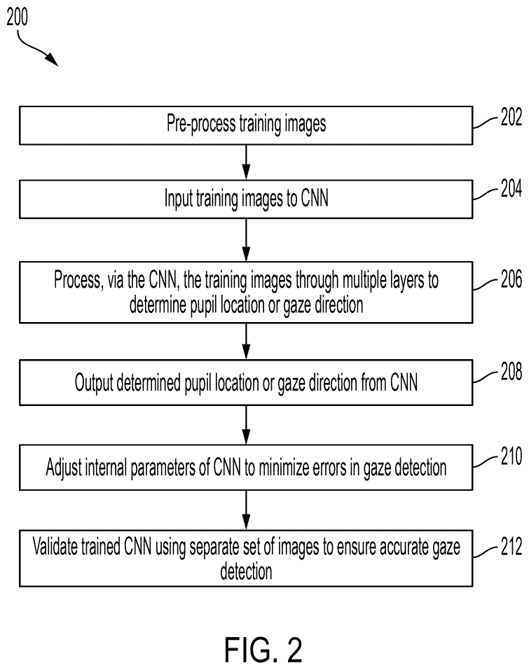

FIG. 2 provides for a method of training a CNN 200 according to one or more embodiments of the present disclosure. Training images may be used in the process of training the CNN, which, optionally, may be pre-processed 202. Training images can be provided as an input in step 204 to the CNN. The training images may be processed through multiple layers of the CNN to determine gaze direction 206. The CNN model may then output the images with a determination of gaze direction 208. The output from the CNN can be compared to the ground truth data associated with the training images to determine the accuracy of the CNN. The training can result in a loss function that can be used to correct or adjust the weights of the CNN. For example, in some embodiments, adjustments to internal parameters of the CNN are made in order to minimize errors in gaze detection 210. The training can be repeated until an error threshold is reached which can define the trained CNN model. In an embodiment, a separate set of images with known parameters may be used to validate the outputs of the CNN model to ensure accurate gaze detection 212.

As mentioned, prior to using images for CNN training, the images can be pre-processed 202. The dataset used for training may contain many images of each subject with different combinations of pitch, vertical viewing angles, and horizontal viewing angles. Images with zero pitch value or near zero pitch value can be selected for training. Images with non-near zero pitch value can often be manually rejected by a person who is taking the pictures or by the system automatically. A DLIB library can also be provided for training. Facial feature points can be extracted from the DLIB library prior to being used for training. Using the extracted facial feature points, eye regions can be cropped using a bounding box technique developed to ensure that the entire eye fits in that region. These cropped regions can be manually annotated and input into the network for training. Further pre-processing can include where each image can be further modified by splitting the image into two sub-images where each sub-image may have one of the two eyes in the original image. Additionally, the right eye (from the viewers point of view) image can be mirrored to look like the left eye image. After splitting, each sub image can be resized to 120×80×3 pixels which can be the input size for the network.

In one or more embodiments, the model can be trained using a Mean Squared Logarithmic Error loss function. For optimization of the model, adaptive moment estimation (“Adam”), which is a stochastic optimization machine learning algorithm can be used with a learning rate of 0.0001. The model can be trained for 40 epochs and can use at least 2,258 training images.

FIG. 3 can be a CNN architecture for detecting eye gaze 300 according to an embodiment of the present disclosure. The architecture of the model can consist of five convolution layers at 302, 310, 314, 316, and 318 and three fully connected layers at 322, 330, and 338. It should be appreciated that there may be more or less than five convolution layers and more or less than three fully connected layers in the architecture 300. The activation layer that can be used for all hidden layers is ReLU at 306, 326, and 334 and dropouts 328 and 336 can be used after the first and second dense layers 322 and 330. Batch normalization can be used at 304, 324, and 332 after the first convolution layer 302 and also after the first and second dense layer 322 and 330.

Images are first input into the CNN model at the first convolution layer 302. The CNN model can take grey scale image inputs with dimensions of 120×80×3 in the present embodiment. The input can then pass to batch normalization 304. In the normalization layer, a local response normalization can be used on the data input. After normalization, the data can go through a ReLU layer 306. ReLU is a non-linear activation function used in multi-layer neural networks. Pooling can then be used at layer 308 before being passed to the second convolution layer at 310.

After the second convolution layer 310, the data can pass through a second pooling function 312 before moving to the following three convolution layers at 314, 316, and 318. Data can pass from one convolution layer directly to the next with no intervening layer at these convolutional layers of the CNN model.

Following the five convolution layers, the data can pass through another pooling layer 320 before passing to the first fully connected layer 322. Following both the first fully connected layer 322 and the second fully connected layer 330 there can be additional batch normalization layers 324 and 332, ReLU layers 326 and 334, and dropout layers 328 and 336. The data passes through a final fully connected layer 338 which outputs the x and y coordinates of the center of the pupil. To store the annotations, a dictionary can be used to contain the image names and their respective “x” and “y” annotations. The pupil identification method can allow the CNN to pass these annotations as ground truth values to the network without any red marks on the images denoting the center of the pupil.

The trained model can generally perform well on images having exposure values close to the exposure values of the training images. For images that have a different exposure range, an algorithm can be used to adjust the brightness of the input image for the CNN eye gaze detection model 400 as shown in FIG. 4. First, the algorithm can sum up the luminance element from the hue, saturation, and luminance (“HSV”) 402 of the test image. The luminance sum can be used to identify an image which may perform the best (or have the highest accuracy) in the CNN algorithm. The best or most accurate image can be assigned a “reference value,” which can be 322308. Next, the reference value can be divided by the summed-up luminance value part of the HSV version of a given test image in step 404. The ratio of the reference value to the luminance of the test image can be referred to as a reference ratio. The brightness of the given test image can be enhanced using the reference ratio and the ImageEnhance.Brightness function from a Python Imaging Library (PIL) in step 406. The reference ratio can be passed as a parameter to the function for modifying the image. After enhancement, the algorithm can pass the image with adjusted brightness into the CNN model of FIG. 3 for eye gaze detection.

When the luminance value part of a test image is divided by the reference value, it can determine a factor by which the test image brightness varies with respect to the reference image. And when image enhancement is performed by using the reference value, it can bring the brightness of the test image to the level of the reference image. The CNN can more accurately determine gaze direction with brightness levels similar to the reference image. For images with a brightness lower than the reference brightness, the algorithm can be able to increase the brightness of the image to the reference image. Similarly, the algorithm can decrease the brightness if the image is brighter than the reference image. The brightness adjustment technique can help in the sense that it may not be required to train the CNN network with images of different brightness. The CNN network can instead be trained using a given dataset which can be collected using a constant brightness. Additionally, brightness normalization can help with datasets that may not have a lot of population diversity. The brightness adjustment algorithm can take care of brightness issues around the iris and surrounding area and can eliminate or substantially reduce bias.

The brightness adjustment can have an effect on the detection of the eye center as well. When the brightness is adjusted to that of a reference image, the black region of the eye can become more obvious and distinguishable from the white region. Brightness adjustment can improve the performance of the CNN and results accuracy.

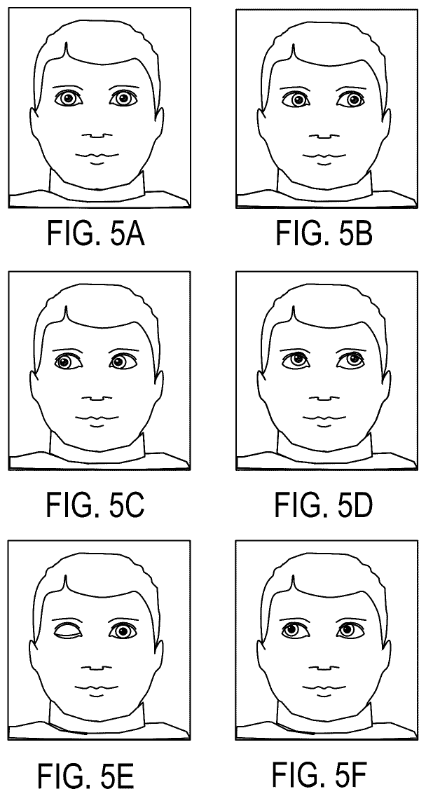

FIGS. 5A-5F are embodiments of eye gaze detection training scenarios according to embodiments of the present disclosure. The images can be used as training material for the CNN network after appropriate brightness normalization. FIG. 5A is an image where the detected eye gaze can be determined to be straight ahead or towards the image capturing device. The detection of straight ahead can be useful for determination in instances of the present disclosure that can be implemented in identification card photography. FIGS. 5B, 5C, 5D, and 5F are images where the detected eye gaze can be away from the image capturing device. These figures depict a situation which may be flagged in identification card photography, according to an embodiment of the present disclosure, as being inadequate photos for use. FIG. 5E is an embodiment where one of the eyes can be detected in the closed position. In this instance, the CNN network may only report the eye gaze direction of a single eye along with a warning that the second eye can be detected as closed.

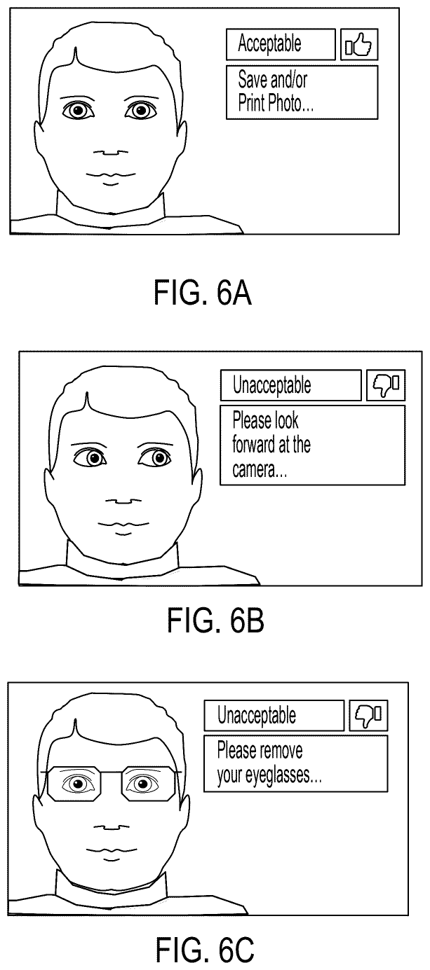

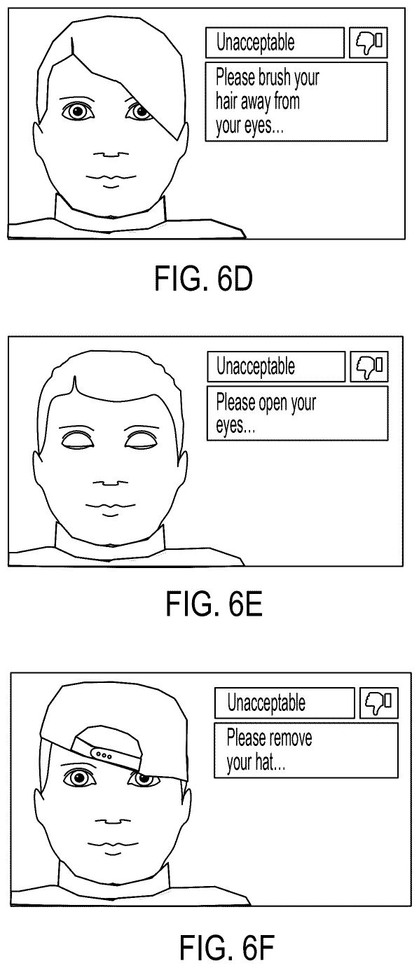

FIGS. 6A-6F are embodiments of feedback from the disclosed eye gaze detection algorithm. FIG. 6A is a first implementation where the algorithm detects that the eye gaze may be straight ahead or directly at the image capturing device. The detected eye gaze direction can be determined as acceptable for the desired use. In some embodiments, the image recording device may take pictures or video recordings when the eye gaze is detected in this position. FIGS. 6B-6F provide unacceptable scenarios as detected by the eye gaze detection algorithm. FIG. 6B provide an instance where the eye gaze can be detected as not straight ahead or towards the image capturing device. The algorithm can detect the direction of the gaze and provide a warning that the photo may be unacceptable.

FIGS. 6C-6F provide other instances where the eye gaze detection algorithm may detect an unacceptable photo. FIG. 6C is an embodiment where the presence of eyeglasses may obscure the eyes. Obscuring the eyes can prevent the eye gaze detection algorithm from detecting the correct gaze direction. FIG. 6D is an embodiment where hair can partially or completely obscure at least one of the eyes for detecting eye gaze direction. FIG. 6E is an embodiment where the eyes can be determined as closed and no pupils are detected. FIG. 6F is an embodiment where clothing, such as a hat, can partially or completely obscure at least one eye.

In response to the unacceptable photo the algorithm can provide audio and/or visual instructions to bring the subject's eye gaze into compliance with the selected eye gaze direction. The instructions can be indicated through the use of a user interface such as the interface displayed in FIGS. 6A-6F. For example, the instructions may state “please open your eyes” or “please remove your hat,” if the algorithm identifies an inability to detect one or both eyes. If the algorithm successfully detects both eyes, but the output of the CNN model determines that the eye gaze direction is not toward the direction of the image capturing device, the algorithm may provide instructions such as “please look at the camera.”

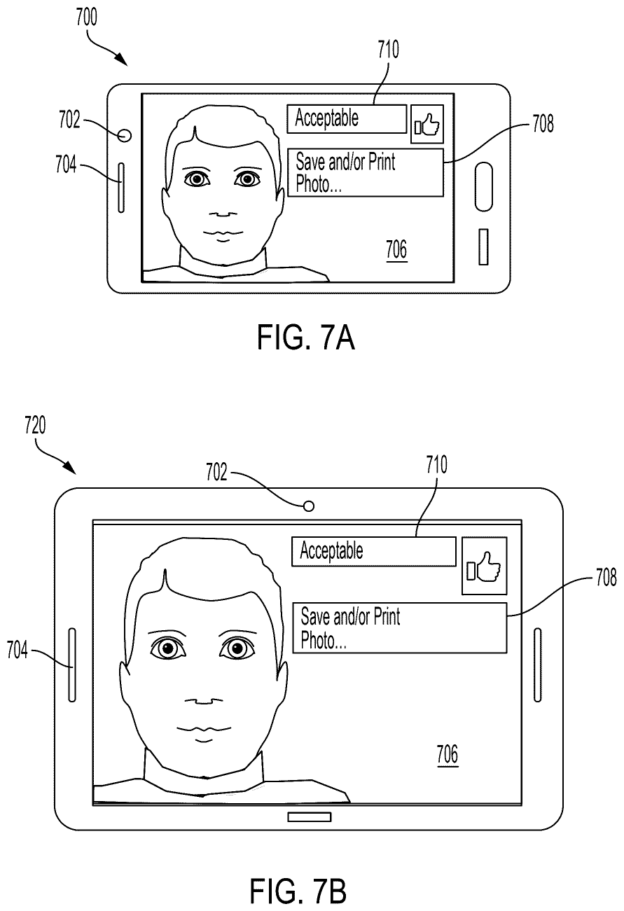

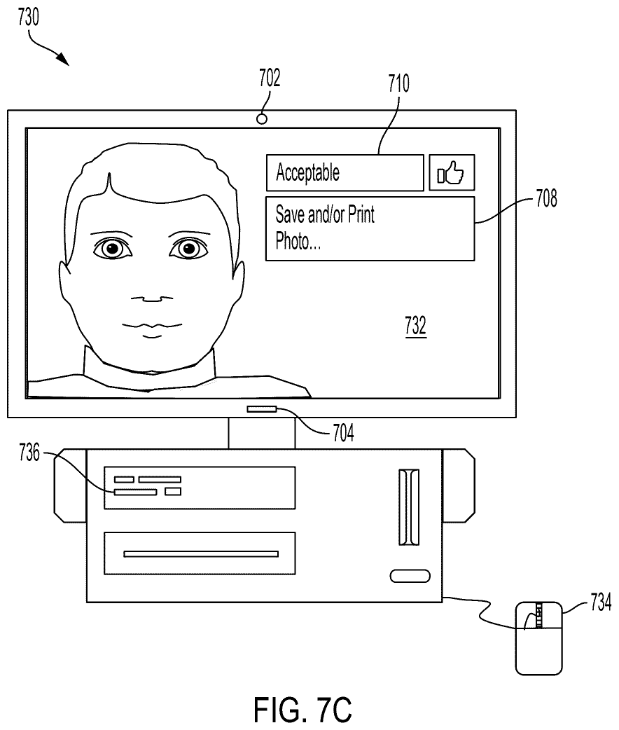

FIGS. 7A-7C provide different systems that can perform the methods describes for the disclosure. These include a smartphone 700 (FIG. 7A), tablet 720 (FIG. 7B), and personal computer 730 (FIG. 7C). These systems commonly provide some form of camera for obtaining the images and a computer processing system for performing the described method. These systems can be used in combination with the feedback described in FIGS. 6A-6F for obtaining images of a person that can meet the requirements of certain identification documentation such as a driver's license or a biometric photo identification which can require a forward-facing gaze for compliance with the document.

For example, FIG. 7A illustrates a smartphone 700 and FIG. 7B illustrates a tablet 720, each of which may include a camera 702, a speaker 704, and a touchscreen 706. The camera 702 functions to capture an image of the user. In various embodiments, when the user's eyes are directed at the camera 702, the CNN model output determines an eye gaze direction that is deemed acceptable. The CNN model may execute locally on the smartphone 700 or the table 720, or the image may be transmitted, over one or more networks, for processing and evaluation. The speaker 704 of the smartphone 700 and the tablet 720 may emit an audio cue or audio message regarding the acceptability of the image taken by the user. The audio cue from the speaker 704 may also include further instructions regarding how to make the image acceptable. The touchscreen 706 of the smartphone 700 and tablet 720 may be used by the user to select one or more options 708 that may be displayed on the touchscreen 706. The touchscreen 706 may also display an output message 710, which may be based on the CNN model output 116, that is, a pupil location or an eye gaze direction. In various embodiments, the output message 710 indicates whether the eye gaze direction in the image is “acceptable” or “unacceptable.”

Regarding FIG. 7C, the personal computer 730 includes a screen 732 that may display the options 708 and the output message 710, as described herein. Additionally, the personal computer 730 may include a camera 702 and a speaker 704, as with the smartphone 700 and the tablet 720. Instead of options being able to be selected directly on the touchscreen 706 by the user, the personal computer 730 may have one or more input devices, such as a mouse 734 and one or more input buttons 736, which can be used to select the one or more options 708 displayed on the screen 732.

Although the disclosure herein has been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the appended claims.

What is claimed is:

1. A computer-implemented method for eye gaze determination in images, comprising:
using a reference image luminous value to adjust a brightness of an image for input to a Convolutional Neural Network (CNN) model;
reducing one or more dimensions of the image;
inputting the image to the CNN model;
determining a location of an eye pupil within the image; and
providing an indication of eye gaze direction for the image.

2. The method of claim 1, further comprising:
extracting facial feature points that include eye features based on a digital library;
annotating eye regions of the image;
cropping the image based on the eye regions; and
training the CNN model using the cropped image.

3. The method of claim 1, wherein the CNN model comprises five convolution layers and three fully connected layers.

4. The method of claim 1, further comprising:
processing the image by a rectified linear activation function (ReLU) after dense and convolution layers and dropout after one or more dense layers as a part of the CNN model.

5. The method of claim 4, wherein the ReLU is used for all convolution layers and the ReLU and dropout are used after a first and second dense layers of the one or more dense layers.

6. The method of claim 1, further comprising:
dividing the reference image luminance value by the luminance value of the image to determine a reference ratio for adjusting the brightness of the image.

7. The method of claim 6, further comprising:
determining the luminance value of the image as the luminance element of a Hue Saturation Luminance (HSV).

8. The method of claim 7, further comprising:
calculating the luminance element of the image as a sum of luminance vectors in the image between 322500 and 327000.

9. The method of claim 1, further comprising:
training the CNN model using an Adaptive Moment Estimation algorithm (Adam) as an optimizer.

10. The method of claim 1, further comprising:
indicating the eye gaze determination for the image by an “x”, “y” location of an eye center, pass/fail indication, visual, or audio cue.

11. The method of claim 1, further comprising:
recording the image when compliant with a selected eye gaze direction.

12. The method of claim 11, further comprising:
providing audio or visual instructions for a live (real time) recording to bring the subject's eye gaze into compliance with the selected eye gaze direction.

13. The method of claim 10, further comprising:
indicating the eye gaze direction through a user interface.

14. The method of claim 1, further comprising:
normalizing the image using batch normalization after a first convolution layer and after the one or more dense layers as a part of the CNN model.

15. A method for training a CNN model to detect eye gaze direction, comprising:
pre-processing a training image, the training image comprising a known eye pupil location or a known eye gaze direction;
inputting the training image to the CNN model;
processing the training image through the CNN model, the CNN model comprising:
one or more convolution layers;
one or more fully connected layers;
one or more activation functions; and
one or more batch normalizations;
producing an output from the CNN model, wherein the output comprises an eye pupil location output or an eye gaze direction output of the training image;
comparing the eye pupil location output to the known eye pupil location or the eye gaze direction output to the known eye gaze direction, wherein a difference in the eye pupil location output to the known eye pupil location and the eye gaze direction output to the known eye gaze direction comprises an error amount;
adjusting internal parameters of the CNN model based at least in part on the error amount; and
creating a training CNN model having adjusted internal parameters.

16. The method of claim 15, further comprising:
validating the trained CNN model using a test set of images with known parameters.

17. The method of claim 15, further comprising:
comparing the eye gaze determination to ground truth data associated with the training image to determine accuracy of the CNN model.

18. The method of claim 15, wherein adjusting the internal parameters of the CNN model comprises minimizing errors in the eye gaze determination.

19. The method of claim 15, wherein the pre-processing of the training image comprises:
extracting facial feature points.

20. The method of claim 19, wherein the pre-processing of the training image further comprises:
splitting the training image into one or more sub-images.
